(19) United States
(12) Patent Application Publication
(10) Pub. No.: US 2008/0001429 A1
(43) Pub. Date: Jan. 3, 2008

(54) Panel materials for vehicles and enclosures

(76) Inventors: Christopher D. Willis, Lanesboro, MA (US); Peter James Zuber, Pittsfield, MA (US); Richard David Hemstreet, Warren, MI (US)

Correspondence Address: MARK L. WARZEL, 10252 OVERHILL DRIVE, SANTA ANA, CA, 92705, US

(21) Appl. No.: 11/799,752

(22) Filed: May 1, 2007

Related U.S. Application Data
(60) Provisional application No. 60/746,084, filed on May 1, 2006.

(51) Int. Cl. B62D 29/04

(52) U.S. Cl. 296/181.2

(57) ABSTRACT

A fiber reinforced polymer material having an improved combination of characteristics. The polymer material generally comprises a fiber reinforced polymer resin containing reinforcing fibers and having a porosity between about 0% to about 95% by volume of the polymer material. The fiber reinforced polymer material may form a panel or substrate material that helps resist impact and/or environmental loading. Typically, such a material includes a fiber reinforced thermoplastic or thermoset support layer that has a skin layer on one or both sides, which are joined to one another to form the substrate or panel material. The exterior skin layer typically includes a polymer resin that may also include a support structure, such as reinforcing fibers. The resulting material is typically lightweight and has a reduced basis weight, particularly as compared to current commercial products, in addition to a low thermal expansion such that it provides improved resistance to delamination, improved dimensional stability and flexibility, and decreased water absorption and retention.

### CROSS REFERENCE TO RELATED APPLICATIONS

This application claims the benefit of Provisional Patent Application No. 60/746,084, filed May 1, 2006, which is hereby incorporated by reference in its entirety.

### FIELD OF THE INVENTION

The present invention relates to panel materials formed from fiber reinforced polymeric materials, and particularly to such panel materials that are suitable for use in vehicles and enclosures. More particularly, the invention relates to materials useful to form substrates and panel materials for recreational vehicles and similar constructed modular housing. Although not limited thereto, the invention is generally useful in the manufacture of automotive, rail, bus, marine, aerospace, and construction articles and materials in which the improved characteristics provide advantages over other materials utilized for such applications.

### BACKGROUND OF THE INVENTION

Driven by a growing demand by industry, governmental regulatory agencies and consumers for durable and inexpensive products that are functionally comparable or superior to metal and other current commercial products, a continuing need exists for improvements in materials subjected to difficult service conditions. This is particularly true in the automotive and construction industries where developers and manufacturers of articles for automotive and construction materials applications must meet a number of competing and stringent performance specifications.

In the case of certain areas of commercial interest, such as the recreational vehicle industry, panel and substrate materials currently in use (typically based on luan wood sheet material) suffer from a number of limitations and problems, including: thermal instability, inconsistency of product characteristics, product variations (thickness, moisture content and surface quality), weight variability in as-provided material and due to moisture uptake (during storage, assembly and end use), long supply lead time (due to foreign supply), limited size availability, read/print through and assembly seam problems, pre-processing requirements (e.g., drying and perforation), and warpage (e.g., due to drying). It would therefore represent a significant advantage and improvement if these problem areas could be alleviated or removed completely through the use of new materials possessing at least some of the following end-use characteristics: environmental stability (e.g. low thermal expansion), moisture resistance, improved surface appearance, long term performance and material life (e.g., good weatherability and mechanical and impact properties), dimensional stability and sound dampening characteristics, low weight, and reduced or odorless character. Such materials might also possess desirable manufacturing characteristics, including: reduced handling, specialized inventory storage, pre-processing and number of components, minimized assembly seams and read through, larger or continuous sheet size availability, reduced potential for delamination, and improved product quality and consistency.

A continuing need therefore exists to provide further improvements in the ability of materials to satisfy such performance and property goals.

### BRIEF DESCRIPTION OF THE INVENTION

The present invention is addressed to the aforementioned needs in the art and provides a material that, among other applications, is useful for producing and/or forming panels used in vehicles and enclosures. The present invention provides a material that meets at least some of the needs and possesses at least some of the advantageous characteristics noted above.

Accordingly, in one aspect of the invention, a panel formed from a fiber reinforced polymer material is provided, in which the polymer material generally comprises a fiber reinforced polymer resin having fibers dispersed therein. The fiber reinforced polymer material generally has a porosity between about 0% to about 95% by volume of the polymer material.

The fiber reinforced polymer material may form a panel or substrate material that helps resist impact and/or environmental loading. Typically, such a material includes a fiber reinforced thermoplastic or thermoset support layer that has a skin layer on one or both sides, which are joined to one another to form the substrate or panel material. The exterior skin layer typically includes a polymer resin that may also include a support structure, such as reinforcing fibers. The resulting material is typically lightweight and has a reduced basis weight, particularly as compared to current commercial products, in addition to a low thermal expansion such that it provides improved resistance to delamination, improved dimensional stability and flexibility, and decreased water absorption and retention.

In another more particular aspect of the invention, a panel or substrate material useful in forming building or vehicular panels is provided. The substrate or panel material may include a support layer composed of a thermoplastic or thermoset material and a skin layer joined to the support layer, wherein the support layer and/or skin layer may also include a support structure, such as reinforcing fibers and the like.

### BRIEF DESCRIPTION OF THE DRAWINGS

FIG. 1 is a side view of a substrate according to one embodiment of the present invention.

FIG. 2 presents thermal expansion results as discussed in the Examples.

### DETAILED DESCRIPTION OF THE INVENTION

The present invention is more particularly described in the following description and examples that are intended to be illustrative only. Within the context of the invention, numerous modifications and variations therein will be apparent to those skilled in the art.

As used in the specification and the appended claims, the singular forms “a,” “an,” and “the” include plural referents unless the context clearly dictates otherwise. Thus, for example, reference to “a thermoplastic resin” encompasses a combination or mixture of different resins as well as a single resin, reference to “a skin layer” or “a surface layer” includes a single layer as well as two or more layers that may or may not be the same and may be on one or more sides or surfaces of the material, and the like.

Also, as used in the specification and in the claims, the term “comprising” may include the embodiments “consisting of” and “consisting essentially of.” All ranges disclosed herein are inclusive of the endpoints and are independently combinable.

As used herein, certain terms and numerical values or ranges may be approximated. For example, the terms “about” and “substantially” are intended to permit some variation in the precise numerical values or ranges specified. While the amount of the variation may depend on the particular parameter, as used herein, the percentage of the variation is typically no more than 5%, more particularly 3%, and still more particularly 1% of the numerical values or ranges specified. In at least some instances, the approximating language may correspond to the precision of an instrument for measuring the value.

In this specification and in the claims that follow, reference will be made to a certain terms, which shall be defined to have the following meanings:

The term “basis weight” generally refers to the areal density of a fiber reinforced thermoplastic material, typically expressed in grams per square meter (g/m² or gsm) of the material in sheet form. The term “reduced basis weight” refers to a reduction in the basis weight that may be realized for materials and panels according to the invention relative to other materials and panels not having all of the features of the invention. Such other materials include, e.g., the current commercial products used as panels for recreational vehicles, as described above.

The term “panel” generally refers to a sheet that forms a distinct (usually flat) section or component of something. In the context of the present invention, the term “panel” is intended to be consistent with this understanding, provided the panel is suitable for use in the applications described herein, i.e., in vehicles and enclosures, such as body panels, building enclosures, and the like. The term “panel” is not intended to refer to a sheet or film material that is or may not be suitable for such applications.

In general, the panel or substrate materials of the invention include a polymer material formed from one or more polymer resins and fibers dispersed within the polymer resin(s). One or more skin layers, including reinforcing and/or decorative skin layers, may also be included on the surface of the fiber reinforced polymer material. The polymer material, including panel and substrate forms thereof, may be formed into various types of articles, e.g. vehicular or construction/building components, such as interior components and exterior body panels, as well as numerous other articles noted herein. Advantageously, the panel and substrate materials provide improved performance characteristics, such as thermal expansion and delamination resistance, while also providing lightweight materials compared to materials currently in use. Such materials are particularly beneficial in forming body panels for vehicles, especially for large body panels, such as those used in the formation of recreation vehicle sidewalls and large enclosures.

The panel and substrate materials of the invention are able to provide low thermal expansion characteristics while also being lightweight. In certain embodiments, the use of a multi-layer substrate material may provide base strength for the substrate while also providing a finish for the panel. As such, the panel and substrate materials of the invention may include, in one embodiment, at least two layers, a support layer and a skin layer that provides the finish for the body panel, or to which a finishing layer may be added.

In one embodiment, the panel and substrate materials include a support layer to provide support for the panel or substrate. The support layer may be composed of any material or combination of materials that enable the support layer to support the resulting substrate, particularly when used as a body panel in a vehicle. As such, the support layer may be composed of a single material or may include a material that includes a support structure therein. In preferred embodiments of the present invention, the support layer includes a material capable of being molded or formed into different body panel substrates, such as a plastic material. Examples of plastic materials that may be used include thermoplastic and thermoset plastic materials.

In certain embodiments wherein a support structure is included in the support layer, the support structure may be any material capable of improving the flex strength, impact strength and/or modulus of the material used to form the support layer. Examples of support structures that may be used in the support layer include, but are not limited to, glass fibers, carbon fibers, metal fibers, natural fibers or combinations thereof (including those other fibers described herein). While short fibers (e.g. less than about 15 mm) may be used, in select embodiments, the fibers are long fibers. In addition, the support structure may be provided in other forms besides fibers including, but not limited to, particles, tubes, and the like. In general, any support structure capable of providing support to the material used in the support layer may be used in the present invention.

As with the support layer, the skin layer may include a support structure. Examples of support structures that may be used in the skin layer include, but are not limited to, glass fibers, carbon fibers, metal fibers, natural fibers, nano fibers/fibrols, mineral fillers, chemical nucleation agents or combinations thereof. As discussed, the fibers may be continuous, long fibers, short fibers or combinations thereof, or may be non-fibrous in shape.

In one embodiment, it is beneficial for the body panels and substrate materials of the invention to have a low thermal expansion characteristics (growth). For example, since some RV sidewalls can be very long (30-40 ft.) and subject to extreme temperatures (−40° F. to 180° F.), in those embodiments wherein the body panel substrate is an RV sidewall or other large body panel, a low thermal growth will help manage thermal expansion of the wall. This structure provides a means to reduce surface deformation, thereby reducing the potential for delamination and/or fracture and subsequent failure of a body panel material.

As described herein, the panel or substrate material of the invention may be non-porous or porous. Advantageously, the polymer material of the panel or substrate material is porous and has a porosity greater than about 0% to less than about 95% by volume of the thermoplastic or thermoset polymer material, more particularly between about 20% to about 80% by volume, and still more particularly between about 30% to about 70% by volume of the polymer material. While not required, it is also possible that the panel or substrate material, which includes the fiber reinforced polymer material, is non-porous or has a porosity within the aforementioned ranges; i.e., the porosity of the panel or substrate material may generally vary between about 0% and about 95% of the total volume of the composite material.

Generally, the areal density of the fiber reinforced polymer material, particularly when in panel or substrate material form, varies from about 400 g/m² to about 4000 g/m², more particularly the basis weight is less than about 3000 g/m², still more particularly less than about 2400 g/m², and even more particularly less than about 1600 g/m².

The thermoplastic resin may generally be any polymer resin, i.e., thermoplastic or thermoset polymeric resins, having a melt temperature below the resin degradation temperature. Non-limiting examples of such resins include polyolefins, thermoplastic polyolefin blends, polyvinyl polymers, butadiene polymers, acrylic polymers, polyamides, polyesters, polycarbonates, polyestercarbonates, polystyrenes, acrylonitrylstyrene polymers, acrylonitrile-butylacrylate-styrene polymers, polyimides, polyphenylene ether, polyphenylene oxide, polyphenylenesulphide, polyethers, polyetherketones, polyacetals, polyurethanes, polybenzimidazole, and copolymers or mixtures thereof. Other resins can be used that can be sufficiently softened by heat to permit fusing and/or molding without being chemically or thermally decomposed during processing or formation of the panel or substrate material. Such other suitable resins will generally be apparent to the skilled artisan.

In more particular embodiments, the polymer resin may include, but is not limited to, acrylonitrile-butadiene-styrene (ABS), polycarbonate (LEXAN® and LEXAN® EXL LEXAN® SLX resins commercially available from General Electric Company), polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide (NORYL GTX® resins from General Electric Company), blends of polycarbonate/polyethylene terephthalate (PET)/polybutylene terephthalate (PBT), polybutylene terephthalate and impact modifier (XENOY® resins commercially available from General Electric Company), polyamides, phenylene sulfide resins, polyvinyl chloride (PVC), high impact polystyrene (HIPS), low/high density polyethylene, polypropylene and thermoplastic olefins (TPO), or combinations thereof.

Fibers suitable for use in the invention include glass fibers, carbon fibers, graphite fibers, synthetic organic fibers, particularly high modulus organic fibers such as para- and meta-aramid fibers, nylon fibers, polyester fibers, or any of the thermoplastic resins mentioned above that are suitable for use as fibers, natural fibers such as hemp, sisal, jute, flax, coir, kenaf and cellulosic fibers, mineral fibers such as basalt, mineral wool (e.g., rock or slag wool), wollastonite, alumina silica, and the like, or mixtures thereof, metal fibers, metalized natural an/or synthetic fibers, ceramic fibers, or mixtures thereof. The fiber content in the polymer resin may is not particularly limited, but may be typically in the range from about 15% to about 85%, more particularly from about 45% to about 60%, by weight of the polymer resin. Fibers suitable for use herein are further described in the patent literature.

While not limited thereto, the fibers dispersed within the polymer resin, forming the fiber reinforced polymer material, generally have a diameter of from about 5 μm to about 22 μm, and a length of from about 5 mm to about 200 mm; more particularly, the fiber diameter may be from about 10 μm to about 22 μm and the fiber length may be from about 5 mm to about 75 mm.

The substrate material may generally be prepared in various forms, such as sheets or films, as layered materials on pre-formed substrates, or in other more rigid forms depending on the particular application need. For certain applications, a panel form is provided that may optionally include one or more additional layers on one or both surfaces of such a panel. Without limitation, such surface or skin layers may be, e.g., a film, non-woven scrim, a veil, a woven fabric, or a combination thereof. The skin or surface layer may be non-porous and may be able to substantially stretch and spread with the fiber reinforced polymer material during processing, such as thermoforming and/or molding operations, and the like. In addition, such layers may be adhesive, including thermoplastic and thermoset materials (e.g., an ethylene acrylic acid copolymer or other such polymers) applied to the surface of the fiber reinforced polymer material.

The thickness of each layer in the panel and substrate materials may vary depending on the final use of the panels and substrates and/or the desired level of support. In one embodiment, the support layer has a thickness of from about 2 to about 5 mm. In an alternative embodiment, the support layer has a thickness of from about 5 to about 10 mm. In still another alternative embodiment, the support layer has a thickness of from about 10 to about 25 mm. The thickness of the skin or surface layer may vary depending on the final use of the substrate and/or the desired characteristics of the skin layer. In one embodiment, the support layer has a thickness of from about 0.1 to about 1.5 mm. In an alternative embodiment, the support layer has a thickness of from about 1.5 to about 10 mm.

The skin layer may be connected to the support layer using any mechanism capable of joining two layers to one another. In one embodiment, heat may be used to partially melt the surface of one or both layers such that a mechanical bond forms between the two layers after the substrate cools. In an alternative embodiment, an adhesive material is used to join the skin layer to the support layer. Some other examples of adhesives that may be used in the present invention include, but are not limited to, one and two-part epoxy adhesives, phenolic adhesives, one and two-part urethane adhesives, urea formaldehyde, or combinations thereof.

The skin layer may be connected to the support layer after the support layer has been formed into a selected shape, or may be applied to the support layer before the overall substrate is then formed into a selected shape. The support layer and/or skin layer may be formed and/or shaped using any method capable of forming a panel or substrate using a laminate. Examples of methods that may be used in the present invention include, but are not limited to, extrusion molding, blow molding, compression molding, injection molding, thermoforming, melt molding (such as co-extrusion molding, T-die extrusion, inflation extrusion, profile extrusion, extrusion coating and multi-layer injection molding) or a combination thereof. Other methods include flat panel hung, cold-formed and/or thermoformed methods.

Advantageously, panel and substrate materials according to the invention provide improved thermal expansion characteristics. For example, the coefficient of thermal expansion of such panels and substrates, while not specifically limited, may be less than about 20 in./in/° F. in a first and/or second direction (e.g., in either or both the flow and crossflow directions), more particularly less than about 12 in./in/° F., and still more particularly less than about 10 in./in/° F. In addition, the panel and substrate materials may be substantially isotropic or anistropic in the linear expansion characteristics. For example, while not necessarily limited, the coefficients of thermal expansion in first and second directions (e.g., perpendicular directions) may generally differ by less than about 10% or may differ by greater than 10%. In other embodiments, the coefficients of thermal expansion in such first and second directions may differ by less than about a factor of two.

The panel and substrate materials of the invention provide additional advantages, particularly over current panel materials used for recreational vehicles. Such improvements include improved resistance to delamination, improved dimensional stability and flexibility, and decreased water absorption and retention. For example, in the area of water absorption and retention, panel materials of the invention generally absorb much less water and retain the absorbed moisture for much less time than panel materials containing wood (such as current RV panel materials). Indeed, the inventive panels and substrate materials generally typically absorb less than about 5 wt. % water after immersion in water for 50 hrs., and more particularly less than about 2 wt. % water after immersion in water for 50 hrs. By comparison, wood containing RV panels typically absorb much greater amounts of water (as much as 50-60 wt. % over similar time periods). Water retention time periods for the panels and substrate materials of the invention are also much less than wood containing panel materials (typically less than about an hour compared with about 8 hrs. for wood).

The panel and substrate materials of the invention may be used to form various intermediate and final form articles, including construction articles or articles for use in vehicular applications, including, without limitation, side wall panels such as for vehicles including recreational vehicles (trailers, motor homes, and the like), trucks, and automobiles, as well as rail, marine and air/aerospace vehicles, cargo liners and container panel and substrates, and the like. Other such articles will be apparent to the skilled artisan. For certain applications, the panel and substrate materials may also be molded into various articles using methods known in the art, for example, pressure forming, thermal forming, thermal stamping, vacuum forming, compression forming, and autoclaving. Such methods are well known and described in the literature, e.g., see U.S. Pat. Nos. 6,923,494 and 5,601,679. Thermoforming methods and tools are also described in detail in DuBois and Pribble's “Plastics Mold Engineering Handbook”, Fifth Edition, 1995, pages 468 to 498.

It should be noted that while the inventive materials provide an improved combination of characteristics, it is not necessary that all of these characteristics be individually improved. While improvement in each characteristic is certainly desirable, for the purposes described herein, an improvement results if one, more than one, or all of the characteristics described herein is or are improved relative to non-inventive or known materials.

As the polymer resin containing fibers, the polymer material of the invention may, according to one embodiment, include a low density glass mat thermoplastic composite (GMT). One such mat is prepared by AZDEL, Inc. and sold under the trademark SUPERLITE®. Preferably, the areal density of the such a GMT is from about 400 grams per square meter of the GMT (g/m²) to about 4000 g/m², although the areal density may be less than 400 g/m² or greater than 4000 g/m² depending on the specific application needs. Preferably, the upper density should be less than about 4000 g/m², more particularly (as described above) less than about 3000 g/m².

The SUPERLITE® mat is generally prepared using chopped glass fibers, a thermoplastic resin and a thermoplastic polymer film or films and or woven or non-woven fabrics made with glass fibers or thermoplastic resin fibers such as polypropylene (PP), polybutylene terephthalate (PBT), polyethylene terephthalate (PET), polycarbonate (PC), a blend of PC/PBT, or a blend of PC/PET. Generally, PP, PBT, PET, and PC/PET and PC/PBT blends are the preferred thermoplastic resins. To produce the low density GMT, the materials and other additives are metered into a dispersing foam contained in an open top mixing tank fitted with an impeller. The foam aides in dispersing the glass fibers and thermoplastic resin binder. The dispersed mixture of glass and thermoplastic resin is pumped to a head-box located above a wire section of a paper machine via a distribution manifold. The foam, not the glass fiber or thermoplastic resin, is then removed as the dispersed mixture passes through a moving wire screen using a vacuum, continuously producing a uniform, fibrous wet web. The wet web is passed through a dryer to reduce moisture content and to melt the thermoplastic resin. When the hot web comes out of the dryer, a thermoplastic film may be laminated into the web by passing the web of glass fiber, thermoplastic resin and thermoplastic polymer film or films through the nip of a set of heated rollers. A non-woven and/or woven fabric layer may also be attached along with or in place thermoplastic film to one side or to both sides of the web to facilitate ease of handling the glass fiber-reinforced mat. The SUPERLITE® composite is then passed through tension rolls and continuously cut (guillotined) into the desired size for later forming into an end product article. Further information concerning the preparation of such GMT composites, including suitable materials used in forming such composites that may also be utilized in the present invention, may be found in a number of U.S. patents, e.g., U.S. Pat. Nos. 6,923,494, 4,978,489, 4,944,843, 4,964,935, 4,734,321, 5,053,449, 4,925,615, 5,609,966 and U.S. Patent Application Publication Nos. US 2005/0082881, US 2005/0228108, US 2005/0217932, US 2005/0215698, US 2005/0164023, and US 2005/0161865.

After SUPERLITE® sheet material is prepared, it may be further treated to an additional outer surface skin material. Examples of outer surface skin materials that may be used in the present invention include, but are not limited to; liquid, powder, sheet or film is applied or laminated onto the SUPERLITE® sheet. In one embodiment, resultant support layer is a glass-filled polyester resin. The lamination process may be any process capable of binding two layers together including, but not limited to, adhesives and compression to bond the two layers. It should also be noted that materials other than glass-filled polyester sheet or film could be used to establish the exterior surface for applications using the substrates of the present invention including, but not limited to, thermoplastic and/or thermoset sheet and films, paint films (such as those made by Soliant, Avery Dennison and Ashland Chemical Paint Film Products), solvent and/or waterborne paint systems, (such as those made by Sherwin Williams, PPG, Dupont) and metal (e.g. aluminum and/or steel).

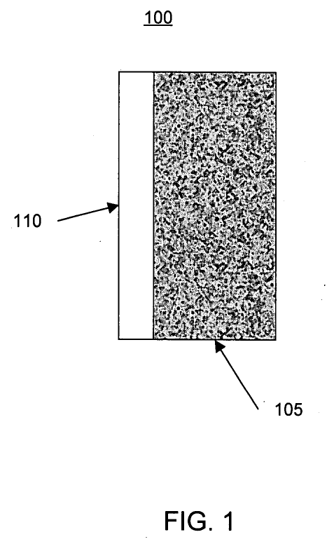

The present invention may be further understood in terms of non-limiting illustrative figures. FIG. 1, for example, is a cross-sectional schematic illustration of a panel or substrate material according to the invention. As shown, the panel or substrate material 100 includes two layers, a support layer 105 and a skin layer 110. In this embodiment, the support layer 105 includes a glass-filled propylene composite (SUPERLITE®) with the skin layer 110 composed of a glass-filled polyester film.

It is to be understood that the concepts of the present invention may also be used in areas other than described herein for panel and substrate materials for vehicles and enclosures. In general, these substrates may be used in any application wherein a lightweight, low thermal expansion, moisture resistant material may be utilized. Such other uses include, without limitation, applications for exterior and interior use in housing (both stick and modular), modular buildings, mobile homes, commercial building construction, and trailers (including consumer to commercial including heavy truck, box or panel “short delivery” trucks).

While the invention has been described in terms of various specific embodiments, those skilled in the art will recognize that the invention can be practiced with modification within the spirit and scope of the claims.

All patents, patent applications, and publications mentioned herein are hereby incorporated by reference in their entireties.

### Experimental

Panel and substrate samples were prepared with various constructions of polymer resins for the support and skin layers at different fiber loadings ranging from 40 wt. % to 55 wt. %. Glass fiber reinforced polymer resin based sheet materials weighing nominally 1200 to 1600 g/m² and having glass fiber contents of 40-55% by weight (SuperLite® sheets, Azdel, Inc., Lynchburg, Va.) were utilized in some of the panel and substrate materials.

### Thermal Expansion Measurements

Thermal expansion measurements were conducted using plaque specimens of 7.675 in. length fixed in a steel jig configured with clamps at one end of the plague and a linear measurement transducer device (LVDT) fixed to the jig frame and attached to the other end of the specimen plaque. Samples fixed in the jig frame were evaluated for thermal expansion characteristics over the temperature range of −40° F. to 180° F.

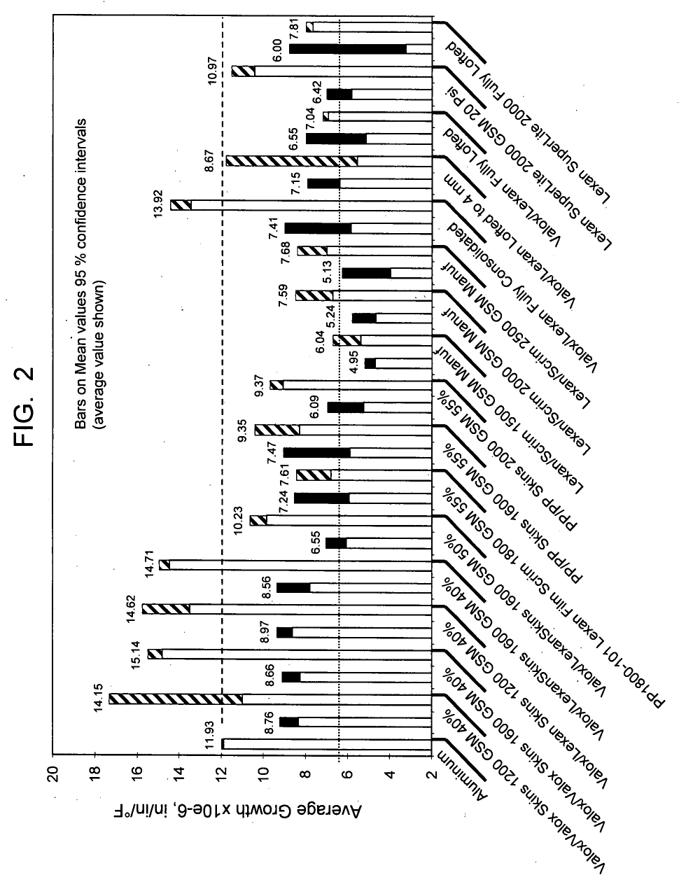

Results for the thermal expansion measurements are shown in FIG. 2. The solid bars in FIG. 2 represent machine direction values and the diagonal dashed bars represent transverse direction values for the materials. Dashed reference lines are also shown in FIG. 2 for aluminum having an average growth of about 12×10⁻⁶ in./in./° F. and steel having an average growth of about 6.5×10⁻⁶ in./in./° F. Comparative current RV materials based on luan constructions were also evaluated yielding average growth values of about 8.3×10⁻⁶ in./in./° F. in the machine direction and about 9.8×10⁻⁶ in./in./° F. in the transverse direction.

What is claimed is:

1. A panel formed from a fiber reinforced polymer material comprising
a polymer resin and
fibers dispersed within the polymer resin,
wherein, the fiber reinforced polymer material has a porosity between about 0% to about 95% by volume of the polymer material.

2. The panel of claim 1, wherein the panel is in the form of a building panel or a vehicular panel.

3. The panel of claim 1, wherein the panel is in the form of a vehicular panel.

4. A vehicular panel according to claim 3, wherein the panel is selected from a recreational vehicle panel, a motor vehicle body panel, a motor vehicle wall panel, a recreational vehicle wall or floor panel, or a motor home sidewall panel.

5. The vehicular panel of claim 3, wherein the panel is in the form of a recreational vehicle panel or a sidewall panel.

6. The panel of claim 1, wherein the panel has a basis weight of less than about 3000 g/m².

7. The panel of claim 1, wherein the panel has a coefficient of thermal expansion in a first direction of less than about 20 in./in/° F.

8. The panel of claim 7, wherein the coefficient of thermal expansion is less than about 12 in./in/° F.

9. The panel of claim 7, wherein the panel has a coefficient of thermal expansion in a second direction perpendicular to the first direction of less than about 20 in./in/° F.

10. The panel of claim 9, wherein the coefficient of thermal expansion in the second direction is less than about 12 in./in/° F.

11. The panel of claim 9, wherein the coefficients of thermal expansion in the first and second directions differ by less than about 10%.

12. The panel of claim 9, wherein the coefficients of thermal expansion in the first and second directions differ by greater than about 10%.

13. The panel of claim 9, wherein the coefficients of thermal expansion in the first and second directions differ by less than about a factor of two.

14. The panel of claim 1, wherein the fiber reinforced polymer material has a porosity between about 20% to about 80% by volume of the thermoplastic material.

15. The panel of claim 14, wherein the fiber reinforced polymer material has a porosity between about 30% to about 70% by volume of the thermoplastic material.

16. The panel of claim 1, wherein the water absorption of the panel is less than about 5 wt. % after immersion in water at ambient temperature for 50 hrs.

17. The panel of claim 16, wherein the water absorption of the panel is less than about 2 wt. % after immersion in water at ambient temperature for 50 hrs.

18. The panel of claim 1, wherein the fiber content of the fiber reinforced polymer material is from about 20 wt. % to about 80 wt. % of the polymer resin.

19. The panel of claim 1, wherein the fibers dispersed within the polymer resin comprise fibers having a diameter greater than about 5 μm and a length from about 5 mm to about 200 mm.

20. The panel of claim 1, wherein the polymer resin is selected from polyolefins, thermoplastic polyolefin blends, polyvinyl polymers, butadiene polymers, acrylic polymers, polyamides, polyesters, polycarbonates, polyestercarbonates, polystyrenes, acrylonitrylstyrene polymers, acrylonitrile-butylacrylate-styrene polymers, polyether imide, polyphenylene ether, polyphenylene oxide, polyphenylenesulphide, polyethers, polyetherketones, polyacetals, polyurethanes, polybenzimidazole, and copolymers or a mixture thereof.

21. The panel of claim 1, wherein the fibers are selected from glass fibers, carbon fibers, graphite fibers, synthetic organic fibers, inorganic fibers, natural fibers, mineral fibers, metal fibers, metalized inorganic fibers, metalized synthetic fibers, ceramic fibers, or a combination thereof.

22. The panel of claim 1, wherein the polymer material is prepared by a method comprising,
adding reinforcing fibers and a polymer resin to an agitated liquid-containing foam to form a dispersed mixture of polymer resin and reinforcing fibers;
depositing the dispersed mixture of reinforcing fibers and polymer resin onto a forming support element;
evacuating the liquid to form a web;
heating the web above the softening temperature of the polymer resin; and
compressing the web to a predetermined thickness to form the polymer material.

23. The panel of claim 1, wherein the panel further comprises a skin layer joined to the polymer material.

24. The panel of claim 23, wherein the skin layer comprises a polymer resin selected from polyolefins, thermoplastic polyolefin blends, polyvinyl polymers, butadiene polymers, acrylic polymers, polyamides, polyesters, polycarbonates, polyestercarbonates, polystyrenes, acrylonitrylstyrene polymers, acrylonitrile-butylacrylate-styrene polymers, polyether imide, polyphenylene ether, polyphenylene oxide, polyphenylenesulphide, polyethers, polyetherketones, polyacetals, polyurethanes, polybenzimidazole, and copolymers or a mixture thereof.

25. The panel of claim 24, wherein the skin layer further comprises fibers selected from glass fibers, carbon fibers, graphite fibers, synthetic organic fibers, inorganic fibers, natural fibers, mineral fibers, metal fibers, metalized inorganic fibers, metalized synthetic fibers, ceramic fibers, or a combination thereof.
